(19) United States
(12) Patent Application Publication
(10) Pub. No.: US 2019/0055421 A1
(43) Pub. Date: Feb. 21, 2019

(54) ELECTROSTATIC INK COMPOSITION

(71) Applicant: HP Indigo B.V., Amstelveen (NL)

(72) Inventors: Guy Nesher, Nes Ziona (IL); Ziv Gilan, Kfar HaRif (IL); Haim Cohen, Modiin (IL); Yaron Grinwald, Meitar (IL); Gil Bar-Haim, Holon (IL)

(21) Appl. No.: 16/079,042

(22) PCT Filed: Jul. 8, 2016
(86) PCT No.: PCT/EP2016/066352

§ 371 Date: Aug. 22, 2018

(51) Int. Cl. C09D 11/12; C09D 11/037; C09D 11/08; G03G 15/08; G03G 9/135

(52) U.S. Cl. CPC C09D 11/12; C09D 11/037; G03G 9/135; G03G 15/0865; C09D 11/08

(57) ABSTRACT

Herein is described an electrostatic ink composition comprising a carrier liquid, aluminium stearate particles, and an aluminium stearate binding agent dissolved in the carrier liquid, wherein the aluminium stearate binding agent comprises an acidic binding group which is bound to an aluminium stearate particle.

### BACKGROUND

Electrophotographic printing processes, sometimes termed electrostatic printing processes, typically involve creating an image on a photoconductive surface, applying an ink having charged particles to the photoconductive surface, such that they selectively bind to the image, and then transferring the charged particles in the form of the image to a print substrate.

The photoconductive surface may be on a cylinder and is often termed a photo imaging plate (PIP). The photoconductive surface is selectively charged with a latent electrostatic image having image and background areas with different potentials. For example, an electrostatic ink composition including charged ink particles in a liquid carrier can be brought into contact with the selectively charged photoconductive surface. The charged ink particles adhere to the image areas of the latent image while the background areas remain clean. The image is then transferred to a print substrate (e.g. paper) directly or, by being first transferred to an intermediate transfer member, which can be a soft swelling blanket, which is often heated to fuse the solid image and evaporate the liquid carrier, and then to the print substrate.

### DETAILED DESCRIPTION

Before the compositions, methods and related aspects of the disclosure are disclosed and described, it is to be understood that this disclosure is not restricted to the particular process features and materials disclosed herein because such process features and materials may vary somewhat. It is also to be understood that the terminology used herein is used for the purpose of describing particular examples. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “liquid carrier”, “carrier liquid”, “carrier,” or “carrier vehicle” refers to the fluid in which the aluminium stearate particles, wax particles, charge directors and/or other additives can be dispersed to form a liquid electrostatic ink or electrophotographic ink. Liquid carriers can include a mixture of a variety of different agents, such as surfactants, co-solvents, viscosity modifiers, and/or other possible ingredients.

As used herein, “electrostatic ink composition” generally refers to an ink composition, which may be in liquid form, generally suitable for use in an electrostatic printing process, sometimes termed an electrophotographic printing process. The electrostatic ink composition may include chargeable particles dispersed in a liquid carrier, which may be as described herein.

As used herein, the term “insoluble resin” is used generally to refer to resins which are insoluble in a carrier liquid of the electrostatic ink composition described herein. In some examples, the insoluble resin is a thermoplastic polymer. In some examples, insoluble resins may be selected from ethylene acrylic acid copolymers; ethylene methacrylic acid copolymers; ethylene vinyl acetate copolymers; copolymers of ethylene (e.g. 80 wt % to 99.9 wt %), and alkyl (e.g. C1 to C5) ester of methacrylic or acrylic acid (e.g. 0.1 wt % to 20 wt %); copolymers of ethylene (e.g. 80 wt % to 99.9 wt %), acrylic or methacrylic acid (e.g. 0.1 wt % to 20.0 wt %) and alkyl (e.g. C1 to C5) ester of methacrylic or acrylic acid (e.g. 0.1 wt % to 20 wt %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt % to 90 wt %)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof. Insoluble resins referred to herein may be polymers selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, and Bynell 2020 (sold by E. I. du PONT)), the Aclyn family of toners (e.g. Aclyn 201 , Aclyn 246, Aclyn 285, and Aclyn 295), and the Lotader family of toners (e.g. Lotader 2210, Lotader, 3430, and Lotader 8200 (sold by Arkema)).

As used herein, “co-polymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic(ally) printing” or “electrophotographic(ally) printing” generally refers to the process that provides an image that is transferred from a photo imaging substrate or plate either directly or indirectly via an intermediate transfer member to a print substrate, e.g. a paper substrate. As such, the image is not substantially absorbed into the photo imaging substrate or plate on which it is applied. Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrophotographic ink composition to an electric field, e.g. an electric field having a field strength of 1000 V/cm or more, in some examples 1000 V/mm or more.

As used herein, the term “about” is used to provide flexibility to a numerical range endpoint by providing that a given value may be a little above or a little below the endpoint. The degree of flexibility of this term can be dictated by the particular variable.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless specified otherwise, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect, there is provided an electrostatic ink composition. The electrostatic ink composition may comprise:

a carrier liquid;

aluminium stearate particles; and

an aluminium stearate binding agent dissolved in the carrier liquid, wherein the aluminium stearate binding agent comprises an acidic binding group which is bound to an aluminium stearate particle.

In an aspect, there is provided a method of preparing an electrostatic ink composition. The method may comprise combining aluminium stearate and an aluminium stearate binding agent comprising an acidic binding group in the presence of a carrier liquid to react the aluminium stearate and aluminium stearate binding agent such that the acidic binding group binds to the aluminium stearate, wherein the aluminium stearate binding agent is dissolved in the carrier liquid.

In an aspect, there is provided an electrostatic printing method. The method may comprise:

providing an electrostatic ink composition;

contacting the electrostatic ink composition with a latent electrostatic image on a surface to create a developed ink image;

transferring the developed ink image to a print substrate,

the electrostatic ink composition comprising:

a carrier liquid;

aluminium stearate particles; and

an aluminium stearate binding agent dissolved in the carrier liquid, wherein the aluminium stearate binding agent comprises an acidic binding group which is bound to an aluminium stearate particle.

### Carrier Liquid

The electrostatic ink composition may include a carrier liquid. In some examples, the electrostatic ink composition comprises aluminium stearate particles and optionally wax particles dispersed in a liquid carrier. The liquid carrier can include or be a hydrocarbon, silicone oil, vegetable oil, etc. The liquid carrier can include, for example, an insulating, non-polar, non-aqueous liquid that can be used as a medium for ink particles, e.g. wax particles. The liquid carrier can include compounds that have a resistivity in excess of about 10⁹ ohm·cm. The liquid carrier may have a dielectric constant below about 5, in some examples below about 3. The liquid carrier can include hydrocarbons. The hydrocarbon can include, for example, an aliphatic hydrocarbon, an isomerized aliphatic hydrocarbon, branched chain aliphatic hydrocarbons, aromatic hydrocarbons, and combinations thereof. Examples of the liquid carriers include, for example, aliphatic hydrocarbons, isoparaffinic compounds, paraffinic compounds, dearomatized hydrocarbon compounds, and the like. In particular, the liquid carriers can include, for example, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

The liquid carrier can constitute about 20% to 99.5% by weight of the electrostatic ink composition, in some examples 50% to 99.5% by weight of the electrostatic ink composition. The liquid carrier may constitute about 40 to 90% by weight of the electrostatic ink composition. The liquid carrier may constitute about 60% to 80% by weight of the electrostatic ink composition. The liquid carrier may constitute about 90% to 99.5% by weight of the electrostatic ink composition, in some examples 95% to 99% by weight of the electrostatic ink composition.

The electrostatic ink composition, when printed on a print substrate, may be substantially free from liquid carrier. In an electrostatic printing process and/or afterwards, the liquid carrier may be removed, e.g. by an electrophoresis processes during printing and/or evaporation, such that substantially just solids are transferred to the print substrate. Substantially free from liquid carrier may indicate that the ink printed on the print substrate contains less than 5 wt % liquid carrier, in some examples, less than 2 wt % liquid carrier, in some examples less than 1 wt % liquid carrier, in some examples less than 0.5 wt % liquid carrier. In some examples, the ink printed on the print substrate is free from liquid carrier.

### Aluminium Stearate

The electrostatic ink composition may comprise aluminium stearate particles.

As used herein, the term “aluminium stearate” refers to an aluminium salt of octadecanoic acid. Aluminium stearate may comprise aluminium mono-stearate, aluminium di-stearate, aluminium tri-stearate or combinations thereof. In some examples, aluminium stearate comprises aluminium di-stearate, aluminium tri-stearate or combinations thereof. In some examples, aluminium stearate comprises a combination of aluminium di-stearate and aluminium tri-stearate. In some examples, the aluminium stearate is VCA (available from Sigma Aldrich).

In some examples, aluminium stearate particles consist essentially of or consist of aluminium stearate.

In some examples, the aluminium stearate particles contained in the electrostatic ink composition have an average particle size (e.g. D50 particle size distribution), for example a volume average particle size, of less than about 1 μm, for example less than about 0.5 μm. In some examples, the aluminium stearate particles contained in the electrostatic ink composition have an average particle size, for example a volume average particle size, of about 0.05 μm or greater, for example about 0.1 μm or greater. In some examples, the aluminium stearate particles contained in the electrostatic ink composition have an average particle size, for example a volume average particle size, in the range of about 0.05 μm to about 1 μm, for example about 0.1 μm to about 0.5 μm, or about 0.1 μm to about 0.4 μm. The average particle size (e.g. D50 particle size distribution) of the aluminium stearate particles may be determined using laser diffraction, for example using a Malvern Masterizer 2000.

In some examples, the LEP electrostatic ink composition is prepared using aluminium stearate particles having an average particle size (e.g. D50 particle size distribution), for example a volume average particle size, of greater than about 1 μm, for example greater than about 2 μm, greater than about 5 μm or greater than about 10 μm. In some examples, the aluminium stearate particles used to prepare the electrostatic ink composition have an average particle size, for example a volume average particle size, of less than about 100 μm, for example less than about 50 μm. In some examples, the aluminium stearate particles used to prepare the electrostatic ink composition have an average particle size, for example a volume average particle size, in the range of about 1 μm to about 100 μm, for example about 10 μm to about 50 μm. The average particle size (e.g. D50 particle size distribution) of the aluminium stearate particles may be determined using laser diffraction, for example using a Malvern Masterizer 2000. The aluminium stearate particles used to prepare the electrostatic ink composition may be ground to provide aluminium stearate particles having an average particle size in the range of about 0.05 μm to about 1 μm, for example about 0.1 μm to about 0.5 μm, or about 0.1 μm to about 0.4 μm.

In some examples, the aluminium stearate particles constitute at least about 1 wt % of the solids of the electrostatic ink composition, for example at least about 2 wt % of the solids of the electrostatic ink composition, at least about 3 wt % of the solids of the electrostatic ink composition, at least about 4 wt % of the solids of the electrostatic ink composition, or at least about 5 wt % of the solids of the electrostatic ink composition. In some examples, the aluminium stearate particles constitute up to about 25 wt % of the solids of the electrostatic ink composition, for example up to about 20 wt % of the solids of the electrostatic ink composition, up to about 15 wt % of the solids of the electrostatic ink composition, at least about 3 wt % of the solids of the electrostatic ink composition, or up to about 13 wt % of the solids of the electrostatic ink composition. In some examples the aluminium stearate particles constitute from about 1 wt % to about 20 wt % of the solids of the electrostatic ink composition, for example about 5 wt. % to about 13 wt. % of the solids of the electrostatic ink composition.

In some examples, the electrostatic ink composition comprises at least about 0.05 wt. % aluminium stearate particles by total weight of the composition, in some examples at least about 0.1 wt. % aluminium stearate particles by total weight of the composition. In some examples, the electrostatic ink composition comprises up to about 2 wt. % aluminium stearate particles by total weight of the composition, for example up to about 1 wt. % aluminium stearate particles by total weight of the composition, or up to about 0.5 wt. % aluminium stearate particles by total weight of the composition. In some examples, the electrostatic ink composition comprises about 0.1 wt. % to about 1 wt. % aluminium stearate particles by total weight of the composition, for example from about 0.1 wt. % to about 0.5 wt. % aluminium stearate particles by total weight of the composition.

In some examples, the electrostatic ink composition comprises aluminium stearate in an amount greater than the amount of aluminium stearate binding agent by molar amount. In some examples, the electrostatic ink composition comprises aluminium stearate and an aluminium stearate binding agent in amounts such that the molar ratio of aluminium stearate to aluminium stearate binding agent is at least about 1:1, for example greater than about 1:1. In some examples, the molar ratio of aluminium stearate to aluminium stearate binding agent in the electrostatic ink composition is in the range of about 10:1 to about 1:1, for example in the range of about 5:1 to about 1:1, or about 4:1 to about 1:1.

### Aluminium Stearate Binding Agent

The electrostatic ink composition may comprise an aluminium stearate binding agent. The aluminium stearate binding agent may comprise an acidic binding group for binding with aluminium stearate. In some examples, the electrostatic ink composition comprises an aluminium stearate binding agent comprising an acidic binding group which is bound to an aluminium stearate particle. The aluminium stearate binding agent may be dissolved in the carrier liquid.

The aluminium stearate binding agent comprises an acidic binding group. In some examples, the acidic binding group may be any acidic group that may undergo an addition reaction with aluminium stearate. The acidic binding group may be selected from acidic groups such as carboxylic acids, phosphoric acid, sulfuric acid, phosphinic acids, phosphonic acids, sulfonic acids, sulfinic acids or derivatives thereof. In some examples, the acidic binding comprises a carboxylic acid, a phosphoric acid or derivatives thereof.

Examples of aluminium stearate binding agents include Dymerex™ (available from Eastman), Disperbky-118 and Disperbky-106 (available from BYK Additives and Instruments).

In some examples, the aluminium stearate binding agent has a molecular weight (Mw) of about 2000 Daltons or less, for example about 1000 Daltons or less, about 900 Daltons or less, about 800 Daltons or less, about 700 Daltons or less, about 600 Daltons or less, or about 500 Daltons or less. In some examples, the aluminium stearate binding agent has a molecular weight in the range of about 100 to about 2000 Daltons, for example about 200 to about 1000 Daltons.

In some examples, the aluminium stearate binding agent comprises a hydrocarbon tail. The hydrocarbon tail group may be selected to be compatible with wax particles which may be present in the electrostatic ink composition. The hydrocarbon tail group may comprise or be a hydrocarbon group, which may be branched or straight chain and may be unsubstituted. The hydrocarbon tail group may comprise or be a hydrocarbon group containing a polyalkylene, which may be selected from a polyethylene, polypropylene, polybutylene. In some examples, the hydrocarbon tail group may contain a polyisobutylene. The hydrocarbon tail group may contain from 10 to 100 carbons, in some examples from 10 to 50 carbons, in some examples from 10 to 30 carbons. The hydrocarbon tail group may be of the formula P-L, wherein P is or comprises polyisobutylene and L is selected from a single bond, (CH₂)ₙ, wherein n is from 0 to 5, in some examples 1 to 5, —O— and —NH—.

In some examples, the aluminium stearate binding agent comprises a succinimide, for example the hydrocarbon tail may further comprise a succinimide.

### Wax Particles

In some examples, the electrostatic ink composition comprises wax particles.

In some examples the wax of the wax particles has a melting point greater than about 120° C., for example greater than about 130° C., or greater than about 140° C. The melting point of the wax particles may be determined according to ASTM 3418.

In some examples, the wax particles may be particles having a generally globular shape, e.g a globular particle. In some examples, a globular particle may be defined as a particle that is not rod-shaped or flat (e.g. flake-shaped). A globular particle may be roughly spherical and/or have a low aspect ratio. In some examples, at least some of the globular particles have an aspect ratio of 1.5 or less, in some examples 1.4 or less, in some examples 1.3 or less, in some examples 1.2 or less, in some examples 1.1 or less. The aspect ratio of a particle may be measured using scanning electron micrograph analysis, and by determining, for a particle, the longest dimension and the shortest dimension and dividing the longest dimension by the shortest dimension. The longest dimension may be the maximum Feret diameter of a particle. The shortest dimension may be the minimum Feret diameter of a particle. A Feret diameter can be described as the distance between the two parallel planes restricting the object perpendicular to that direction.

The wax particles may have a D50 of from 2 μm to 7 μm, in some examples a D50 of from 3 μm to 6 μm, in some examples from 4 μm to 6 μm. The wax particles may have a D90 of 10 μm or less, in some examples a D90 of from 6 μm to 10 μm, in some examples from 7 μm to 9 μm, the D50 and D90, when measured in the liquid carrier using laser diffraction and volume distribution, in accordance with ISO13220. The D50 and D90 may be measured in the liquid carrier using laser diffraction and volume distribution, for example in accordance with ISO13220. The D50 and D90 of the wax particles may be measured in a volume of the liquid carrier before addition of the wax particles in the liquid carrier to the other components of the electrostatic ink composition. The D50 and D90 of the wax particles may be measured by taking a sample of a batch of the wax particles (e.g. the batch being in dry form) and dispersing this in a volume of the liquid carrier and then measuring the D50 and D90, with at least some of the rest of the batch of wax particles, e.g. in dry form, being added to the slurry.

The wax particles may comprise a hydrocarbon. The hydrocarbon may be a polyalkylene, such as polypropylene or polyethylene. The hydrocarbon may be a homopolymer of ethylene or propylene. The hydrocarbon may be an unsubstituted hydrocarbon. An unsubstituted hydrocarbon may be defined as a hydrocarbon lacking functional groups, with a functional group being defined as a group having atoms other than hydrogen and carbon. An unsubstituted hydrocarbon may be defined as a hydrocarbon formed entirely of hydrogen and carbon atoms. In some examples, the hydrocarbon comprises, consists essentially or consists of polyethylene, which may be high density polyethylene. The high density polyethylene may have a density of at least 0.93 g/cm³, in some example at least 0.94 g/cm³, in some examples at least 0.95 g/cm³, in some examples at least 0.95 g/cm³, in some examples at least 0.96 g/cm³, in some examples at least 0.97 g/cm³. The high density polyethylene may have a density of from 0.93 g/cm³ to 0.99 g/cm³, in some examples a density of from 0.93 g/cm³ to 0.98 g/cm³, in some examples a density of from 0.93 g/cm³ to 0.98 g/cm³, in some examples a density of from 0.93 g/cm³ to 0.97 g/cm³, in some examples a density of from 0.94 g/cm³ to 0.97 g/cm³, in some examples a density of from 0.95 g/cm³ to 0.97 g/cm³, in some example at least 0.94 g/cm³, in some examples at least 0.95 g/cm³, in some examples at least 0.95 g/cm³, in some examples at least 0.96 g/cm³, in some examples at least 0.97 g/cm³.

In some examples, at least some, in some examples all, of the wax particles substantially consist of the hydrocarbon. In other words, they may be considered solid particles made substantially entirely of the hydrocarbon. Suitable wax particles include Ceridust 3610, available from Clariant.

In some examples, at least some of the wax particles comprise a non-hydrocarbon core having a shell comprising the hydrocarbon surrounding the core. In some examples, at least some of the wax particles comprise a carbohydrate core having a shell surrounding the core comprising the hydrocarbon. The carbohydrate may be selected from monosaccharides or polysaccharides. The monosaccharides may be selected from pentose and hexose sugars. The monosaccharide may be selected from ribose, arabinose, xylose, lyxose, allose, altrose, glucose, mannose and galactose. The polysaccharide may be a disaccharide, i.e. a carbohydrate comprising molecules of two saccharide units, or a polysaccharide, i.e. a carbohydrate comprising molecules of three or more saccharide units. The disaccharide may have two saccharide units, each of which is independently selected from ribose, arabinose, xylose, lyxose, allose, altrose, glucose, mannose and galactose The disaccharide may be selected from sucrose, lactulose, lactose, maltose, trehalose, cellobiose and chitobiose The polysaccharide may be selected from a saccharide having three or more saccharide units, each of which is independently selected from ribose, arabinose, xylose, lyxose, allose, altrose, glucose, mannose and galactose. Suitable wax particles include Ceridust 8330TP, available from Clariant.

In some examples, the wax particles comprise a fatty acid amide, for example a fatty acid amide of formula R¹C(O)NHCH₂CH₂NHC(O)R², where R¹ and R² are each independently an optionally substituted alkyl group having at least 7 carbon atoms, for example from about 10 to about 26 carbon atoms. In some examples, the wax particles comprises ethylene bis(stearamide). Suitable wax particles include Micromide 520XF (available from Micro powders inc.).

In some examples, the hydrocarbon has a drop point of at least 120° C. The hydrocarbon has a drop point of at least 125° C. The drop point may be from 120° C. to 140° C., in some examples from 120° C. to 135° C., in some examples from 125° C. to 135° C., in some examples from 125° C. to 130° C., in some examples about 128° C. or 129° C. Drop point may be measured according to ASTM D3954-15.

The wax particles may constitute at least 50 wt % of the solids of the electrostatic ink composition, in some examples at least 55 wt % of the solids of the electrostatic ink composition, in some examples at least 60 wt % of the solids of the electrostatic ink composition, in some examples at least 65 wt % of the solids of the electrostatic ink composition, in some examples at least 75 wt % of the solids of the electrostatic ink composition. In some examples the wax particles may constitute from 60 wt % to 98 wt % of the solids of the electrostatic ink composition.

“At least some of the wax particles” may be an amount of 50% by number, in some examples at least 80% by number, in some examples at least 90% by number.

In some examples, the wax particles have an average particle size (e.g. D50 particle size distribution), for example a volume average particle size, of less than about 1 μm, for example less than about 0.5 μm. In some examples, the aluminium stearate particles contained in the electrostatic ink composition have an average particle size, for example a volume average particle size, of about 0.05 μm or greater, for example about 0.1 μm or greater. In some examples, the aluminium stearate particles contained in the electrostatic ink composition have an average particle size, for example a volume average particle size, in the range of about 0.05 μm to about 1 μm, for example about 0.1 μm to about 0.5 μm, or about 0.1 μm to about 0.4 μm. The average particle size (e.g. D50 particle size distribution) of the aluminium stearate particles may be determined using laser diffraction, for example using a Malvern Masterizer 2000.

In some examples, the wax particles are free from resin, for example free from resin which is insoluble in the carrier and/or free from resin having a melting point of less than about 120° C., for example less than about 130° C., or less than about 140° C. In some examples, the electrostatic ink composition is free from resin, for example free from resin which is insoluble in the carrier and/or free from resin having a melting point of less than about 120° C., for example less than about 130° C., or less than about 140° C.

In some examples, the electrostatic ink composition comprises at least 0.1 wt. % wax particles by total weight of the composition, in some examples at least 1 wt. %, in some examples at least 2 wt. %.

In some examples, the electrostatic ink composition comprises up to 10 wt. % wax particles by total weight of the composition.

In some examples, the electrostatic ink composition lacks halogenated compounds, such as polytetrafluoroethylene.

In some examples, the electrostatic ink composition comprises substantially no insoluble resin having a melting point of less than about 140° C., for example less than about 135° C., less than about 130° C., less than about 125° C., less than about 120° C., less than about 115° C., less than about 110° C., less than about 105° C., or less than about 100° C. In some examples, the electrostatic ink composition comprises less than 10 wt. % by total solids content of the composition of insoluble resin having a melting point of less than about 140° C., for example less than about 135° C., less than about 130° C., less than about 125° C., less than about 120° C., less than about 115° C., less than about 110° C., less than about 105° C., or less than about 100° C. In some examples, the electrostatic ink composition comprises less than 5 wt. % by total solids content of the composition of insoluble resin having a melting point of less than about 140° C., for example less than about 135° C., less than about 130° C., less than about 125° C., less than about 120° C., less than about 115° C., less than about 110° C., less than about 105° C., or less than about 100° C. In some examples, the electrostatic ink composition comprises less than 1 wt. % by total solids content of the composition of insoluble resin having a melting point of less than about 140° C., for example less than about 135° C., less than about 130° C., less than about 125° C., less than about 120° C., less than about 115° C., less than about 110° C., less than about 105° C., or less than about 100° C. In some examples, the electrostatic ink composition comprises less than 0.5 wt. % by total solids content of the composition of insoluble resin having a melting point of less than about 140° C., for example less than about 135° C., less than about 130° C., less than about 125° C., less than about 120° C., less than about 115° C., less than about 110° C., less than about 105° C., or less than about 100° C. In some examples, the electrostatic ink composition comprises less than 0.1 wt. % by total solids content of the composition of insoluble resin having a melting point of less than about 140° C., for example less than about 135° C., less than about 130° C., less than about 125° C., less than about 120° C., less than about 115° C., less than about 110° C., less than about 105° C., or less than about 100° C. In some examples, the electrostatic ink composition comprises less than 0.01 wt. % by total solids content of the composition of insoluble resin having a melting point of less than about 140° C., for example less than about 135° C., less than about 130° C., less than about 125° C., less than about 120° C., less than about 115° C., less than about 110° C., less than about 105° C., or less than about 100° C. In some examples the melting point may be as determined according to ASTM D3418.

In some examples, the electrostatic ink composition may be a substantially colorless, clear or transparent composition substantially free from pigment. In examples in which the electrostatic ink compositions are substantially free from pigment, they may be used as adhesion demoters, for example in the examples described herein without contributing a further subtractive effect on the CMYK inks that would substantially affect the color of an underprinted colored image.

As used herein, “substantially free from pigment” is used to describe an electrostatic ink composition in which less than 1 wt % of the solids in the electrostatic ink composition are made up of colorant, in some examples less than 0.5 wt % of the solids in the electrostatic ink composition are made up of colorant, in some examples less than 0.1 wt % of the solids in the electrostatic ink composition are made up of colorant, in some examples less than 0.05 wt % of the solids in the electrostatic ink composition are made up of colorant, in some examples less than 0.01 wt % of the solids in the electrostatic ink composition are made up of colorant.

Examples of waxes that may be used are Micromide 520XF (available from Micro powders inc.), Ceraflour 1000 and 994 (available from BYK), and Ceridust 8330TP (available from Clariant).

### Charge Director

In some examples, the electrostatic ink composition includes a charge director. The charge director may be added to an electrostatic ink composition in order to impart and/or maintain sufficient electrostatic charge on the ink particles. The electrostatic ink composition may include a charge director comprising lecithin or a sulfate-based lipophilic moiety.

In some examples, the charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™, and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates. The charge director can impart a negative charge or a positive charge on the resin-containing particles of an electrostatic ink composition.

The charge director may be added in order to impart and/or maintain sufficient electrostatic charge on the ink particles, which may be particles comprising the thermoplastic resin.

In some examples, the electrostatic ink composition comprises a charge director comprising a simple salt. The ions constructing the simple salts are all hydrophilic. The simple salt may include a cation selected from the group consisting of Mg, Ca, Ba, NH₄, tert-butyl ammonium, Li⁺, and Al⁺³, or from any sub-group thereof. The simple salt may include an anion selected from the group consisting of SO₄²⁻, PO³⁻, NO³⁻, HPO₄²⁻, CO₃²⁻, acetate, trifluoroacetate (TFA), Cl⁻, BF₄⁻, F⁻, ClO₄⁻, and TiO₃⁴⁻ or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)3, LiClO₄ and LiBF₄, or any sub-group thereof.

In some examples, the electrostatic ink composition comprises a charge director comprising a sulfosuccinate salt of the general formula MAₙ, wherein M is a metal, n is the valence of M, and A is an ion of the general formula (I): [R¹—O—C(O)CH₂CH(SO₃⁻)C(O)—O—R²], wherein each of R¹ and R² is an alkyl group. In some examples each of R₁ and R₂ is an aliphatic alkyl group. In some examples, each of R₁ and R₂ independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R₁ and R₂ are the same. In some examples, at least one of R₁ and R₂ is C₁₃H₂₇. In some examples, M is Na, K, Cs, Ca, or Ba.

In some examples, the charge director comprises at least one micelle forming salt and nanoparticles of a simple salt as described above. The simple salts are salts that do not form micelles by themselves, although they may form a core for micelles with a micelle forming salt. The sulfosuccinate salt of the general formula MAₙ is an example of a micelle forming salt. The charge director may be substantially free of an acid of the general formula HA, where A is as described above. The charge director may include micelles of said sulfosuccinate salt enclosing at least some of the nanoparticles of the simple salt. The charge director may include at least some nanoparticles of the simple salt having a size of 200 nm or less, and/or in some examples 2 nm or more.

The charge director may include one of, some of or all of (i) soya lecithin, (ii) a barium sulfonate salt, such as basic barium petronate (BPP), and (iii) an isopropyl amine sulfonate salt. Basic barium petronate is a barium sulfonate salt of a 21-26 hydrocarbon alkyl, and can be obtained, for example, from Chemtura. An example isopropyl amine sulphonate salt is dodecyl benzene sulfonic acid isopropyl amine, which is available from Croda.

In some examples, the charge director constitutes about 0.001% to 20%, in some examples 0.01% to 20% by weight, in some examples 0.01 to 10% by weight, in some examples 0.01% to 1% by weight of the solids of an electrostatic ink composition. In some examples, the charge director constitutes about 0.001% to 0.15% by weight of the solids of the electrostatic ink composition, in some examples 0.001% to 0.15%, in some examples 0.001% to 0.02% by weight of the solids of an electrostatic ink composition, in some examples 0.1% to 2% by weight of the solids of the electrostatic ink composition, in some examples 0.2% to 1.5% by weight of the solids of the electrostatic ink composition in some examples 0.1% to 1% by weight of the solids of the electrostatic ink composition, in some examples 0.2% to 0.8% by weight of the solids of the electrostatic ink composition.

In some examples, the charge director is present in an amount of from 3 mg/g to 20 mg/g, in some examples from 3 mg/g to 15 mg/g, in some examples from 10 mg/g to 15 mg/g, in some examples from 5 mg/g to 10 mg/g (where mg/g indicates mg per gram of solids of the electrostatic ink composition).

### Method of Preparing an Electrostatic Ink Composition

The method may comprise combining aluminium stearate and an aluminium stearate binding agent comprising an acidic binding group in the presence of a carrier liquid to react the aluminium stearate and aluminium stearate binding agent such that the acidic binding group binds to the aluminium stearate, wherein the aluminium stearate binding agent is dissolved in the carrier liquid.

In some examples, the aluminium stearate and aluminium stearate binding agent are combined in amounts such that the molar ratio of aluminium stearate to aluminium stearate binding agent is at least about 1:1, for example greater than about 1:1. In some examples, the molar ratio of aluminium stearate to aluminium stearate binding agent in the electrostatic ink composition is in the range of about 10:1 to about 1:1, for example about 5:1 to about 1:1, or about 4:1 to about 1:1.

In some examples, the method comprises grinding aluminium stearate and an aluminium stearate binding agent in the presence of a carrier liquid to react the aluminium stearate and aluminium stearate binding agent. In some examples, the grinding of takes place in an agitated small media mill (e.g. a S1 attritor). In some examples grinding may be carried out at a temperature in the range of about 20 to 60° C., for example about 25-40° C., or about 30° C. In some examples, grinding may be carried out for at least about 1 hour, for example at least about 2 hours, at least about 4 hours, or about 8 hours. In some examples, grinding may be carried out for about 4 to about 12 hours. In some examples, grinding may be carried out at a speed of at least about 100 rpm, for example at least about 200 rpm, or about 250 rpm. In some examples, grinding may be carried out of a speed of about 100 rpm to about 500 rpm.

In some examples, the method comprises adding wax particles to the electrostatic ink composition. In some examples, wax particles are added to the electrostatic ink composition after the aluminium stearate and aluminium stearate binding agent have reacted.

In some examples, the method comprises adding a charge director to the electrostatic ink composition.

### Electrostatic Printing Method

In some examples, the electrostatic printing method may comprise:

providing an electrostatic ink composition;

contacting the electrostatic ink composition with a latent electrostatic image on a surface to create a developed ink image;

transferring the developed ink image to a print substrate,

the electrostatic ink composition comprising:

a carrier liquid;

aluminium stearate particles; and

an aluminium stearate binding agent dissolved in the carrier liquid, wherein the aluminium stearate binding agent comprises an acidic binding group which is bound to an aluminium stearate particle.

In some examples, the method comprises forming an embellished image on the print substrate by contacting an embellishing material with the print substrate on which the developed ink image is disposed. In some examples, the embellished image is formed as a reverse image of the developed ink image on the print substrate, for example due to the developed ink image demoting adhesion to the embellishing material. In some examples, the embellishing material is a foiling material for producing a foiled image on the print substrate.

In some examples, the method may comprises providing an electrostatic ink composition comprising a carrier liquid, aluminium stearate particles, an aluminium stearate binding agent dissolved in the carrier liquid and wax particles, wherein the aluminium stearate binding agent comprises an acidic binding group which is bound to an aluminium stearate particle.

In some examples, forming an embellished images on the print substrate comprises heating the print substrate. In some examples, the print substrate is heated to a temperature in the range of about 60° C. to about 130° C., for example in the range of about 80° C. to about 120° C.

In some examples, the method may comprise providing a print substrate comprising an adhesive layer. In some examples, the developed ink image is transferred to the print substrate to provide a developed ink image disposed on the adhesive layer on the print substrate.

In some examples, the adhesive layer may comprise a resin having a melting point below about 130° C., for example below about 120° C., below about 110° C., or below about 100° C. In some examples, the adhesive layer comprise an insoluble resin as described herein. In some examples, the insoluble resin has a melting point below about 130° C., for example below about 120° C., below about 110° C., or below about 100° C., for example in the range of about 60 to about 100° C. The melting point of an insoluble resin may be determined according to ASTM D3418.

In some examples, the adhesive layer may be formed by applying a resin composition comprising an insoluble resin to the print substrate. In some examples the resin composition comprises an insoluble resin and a carrier liquid as described herein. In some examples, the resin composition comprises an insoluble resin, a carrier liquid and a charge director. In some examples, the resin composition may be any LEP printing composition, e.g. ElectroInk®, obtained from Hewlett-Packard Company. In some examples, the resin composition is coloured, for examples comprises a colorant, such as a cyan, black, magenta or yellow colorant. In some examples, the resin composition is colourless, for examples comprises substantially no pigment.

In some examples, the resin composition may be liquid electrostatically printed onto the print substrate to provide a print substrate with an adhesive layer.

In some examples, forming an embellished images comprises applying pressure to the print substrate in order to promote adhesion of the embellishing material to the print substrate, for example to the adhesive layer of the print substrate. In some examples, pressure is applied to the print substrate via a series of rollers. In some examples, the rollers are part of a roll laminator, such as a GMP roll laminator (GMP Korea).

In some examples, a foiling film is applied to the print substrate to apply a foiling material to the print substrate to form a foiled image. In some examples, the foiling film is a polymeric film, such as a polyester film or a Teflon® based film. In some examples, the foiling material may be applied to the foiling film before the foiling film together with the foiling material is applied to the print substrate. In some examples the foiling film has a thickness of 200 μm or less, in some examples the polymeric film has a thickness of 100 μm or less, in some examples the polymeric film has a thickness of 50 μm or less.

In some examples, the embellishing material, e.g. foiling film, is removed from the print substrate to leave behind an embellished image. In some examples, embellishing material which was contacted with the developed image, for example a developed ink image, is removed, for example foiling material may be removed along with the foiling film.

In some examples, the foiling material is a metallic material. In some examples the foiling material has a thickness of 200 μm or less, in some examples the foiling material has a thickness of 100 μm or less, in some examples the foiling material has a thickness of 50 μm or less, in some examples the foiling material has a thickness of 25 μm or less.

In some examples, the method comprises cooling the print substrate. In some examples, cooling of the print substrate may be followed by separation of the embellishing material, e.g. a foiling film from the print substrate comprising the embellished image.

### EXAMPLES

The following illustrates examples of the compositions and related aspects described herein. Thus, these examples should not be considered to restrict the present disclosure, but are merely in place to teach how to make examples of compositions of the present disclosure.

### Example 1

An electrostatic ink composition was prepared by grinding aluminium stearate (VCA from Sigma Aldrich) with an aluminium stearate binding agent (Dymerex polymerized rosin, available from Eastman) in a 1:1 molar ratio in the presence of Isopar L in which the aluminium stearate binding agent was dissolved. Grinding was carried out in an S1 attritor for 8 hours at 250 rpm and a temperature of 30° C. The ground material was diluted with additional Isopar L to 0.5% NVS and then mixed with 1 wt. % of Micromide 520XF wax particles (Micro powders inc.) by total weight of the ink composition to create a working solution. The working solution was loaded with 10 mg/g NCD (commercially available charge director, HP Imaging Agent) before printing. The formulation of the electrostatic ink composition is provided in table 1 below.

TABLE 1

| Example 1 Electrostatic | | Wt. % by weight of |
|---|---|---|
| Ink Composition | Mass (g) | total ink composition |
| Aluminium stearate (VCA from | 9.5 | 0.27 |
| Sigma Aldrich) | | |
| Aluminium binding agent (Dymerex | 8 | 0.23 |
| polymerized rosin from Eastman) | | |
| Wax particles (Micromide 520XF | 35 | 1 |
| from Micro powders inc.) | | |
| Carrier liquid (Isopar L from | 3447.15 | 98.49 |
| Exxon Corporation) | | |
| Charge director (HP Imaging Agent) | 0.35 | 0.01 |

The charge director used to charge the above electrostatic ink can be made of soya lecithin, basic barium petronate BBP, isopropyl amine dodecylbenzene sulfonic acid, Oloa 1200 (Chevron), Oloa 1 1000 (Chevron) in isoparaffin (Isopar®-L from Exxon).

### Example 2

An electrostatic ink composition was prepared in the same way as Example 1, except that aluminium stearate and aluminium stearate binding agent were combined in a 4:1 molar ratio.

A liquid electrostatic printing apparatus (HP Indigo 7500 press) comprising a photoconductive member on which a latent electrostatic image can be formed and an intermediate transfer member was used to print the electrostatic ink composition of Example 1 and a resin composition (HP ElectroInk® 4.5) onto a paper print substrate using a one shot mode. In this mode, the electrostatic ink of Example 1 was first contacted with a latent electrostatic image on a surface of a photoconductive member (PIP drum) of the liquid electrostatic printing apparatus to form a developed ink image. The developed ink image was then transferred to the intermediate transfer member (ITM) and another latent electrostatic image was formed on the PIP drum. The resin composition was then contacted with the latent electrostatic image on the PIP drum to form a developed resin image which was then transferred to the ITM. The developed ink image and the developed resin image were then transferred from the ITM to a print substrate such that the developed ink image was disposed on the developed resin image on the print substrate.

After printing, the print substrate was laminated at 115° C. and a speed of 9 m/min (using GMP roll laminator (GMP Korea) Dolphin series) with gold foil. Gold foil only adhered to areas of the print substrate on which the developed ink image was not formed. Therefore, the electrostatic ink composition described herein demotes adhesion. The developed ink image was transparent and colourless such that a coloured resin composition would be visible through the developed ink image. Similar results were achieved when the electrostatic ink composition of Example 2 was printed and the resulting image embellished as described above.

The durability of the electrostatic inks of Examples 1 and 2 were checked by a Scratch resistance test that was done by a Taber scratch tester model 551 using S-20 Tungsten carbide cutting tool. A square print of 400% electrostatic ink coverage with YMCK separation order was printed using YMCK pigmented resin compositions (ElectroInk 4.5 available from HP Indigo), the samples was then overprinted with an image formed from an electrostatic ink composition of Example 1 or Example 2. A reference sample was prepared in the same way except that the YMCK image was not overprinted with an image formed from an electrostatic ink composition. The square prints were scratched by the Tungsten carbide cutting tool while rotating the print and creating a circular damage on the printed substrate. Results were analyzed visually and by weighting the ink debris that was removed by the cutting tool. It was found that the amount of debris was reduced by 50% when the image was overprinted with the electrostatic ink composition of Example 1 or Example 2 (visually the difference was detected by the thickness of the scratch). Therefore, the electrostatic ink composition described herein also exhibits improved durability.

The present inventors have found that a chargeable electrostatic ink composition can be provided without requiring the presence of an insoluble resin as described herein by providing the claimed composition.

While the electrostatic ink compositions, methods and related aspects have been described with reference to certain examples, it will be appreciated that various modifications, changes, omissions, and substitutions can be made without departing from the spirit of the disclosure. It is intended, therefore, that the electrostatic ink compositions, methods and related aspects be limited only by the scope of the following claims. Unless otherwise stated, the features of any dependent claim can be combined with the features of any of the other dependent claims, and any other independent claim.

1. An electrostatic ink composition comprising:
a carrier liquid;
aluminium stearate particles; and
an aluminium stearate binding agent dissolved in the carrier liquid, wherein the aluminium stearate binding agent comprises an acidic binding group which is bound to an aluminium stearate particle.

2. A composition according to claim 1, wherein the amount of aluminium stearate is greater than or equal to the amount of aluminium stearate binding agent by molar equivalents.

3. A composition according to claim 2, wherein the molar ratio of aluminium stearate to aluminium stearate binding agent is in the range of about 10:1 to about 1:1

4. A composition according to claim 1, wherein the aluminium stearate binding agent has a molecular weight (Mw) of less than about 2000.

5. A composition according to claim 1, wherein the acidic binding group of the aluminium stearate binding agent is derived from a carboxylic acid or a phosphoric acid.

6. A composition according to claim 1 further comprising wax particles.

7. A composition according to claim 1, wherein the composition comprises substantially no insoluble resin having a melting point of less than about 120° C.

8. A composition according to claim 1 comprising a charge director comprising lecithin or a sulfate-based lipophilic moiety.

9. A method of preparing an electrostatic ink composition, the method comprising combining aluminium stearate and an aluminium stearate binding agent comprising an acidic binding group in the presence of a carrier liquid to react the aluminium stearate and aluminium stearate binding agent such that the acidic binding group binds to the aluminium stearate, wherein the aluminium stearate binding agent is dissolved in the carrier liquid.

10. A method according to claim 9 wherein the aluminium stearate and the aluminium stearate binding agent are combined in amounts such that the molar ratio of aluminium stearate to aluminium stearate binding agent is at least about 1:1.

11. A method according to claim 9 comprising grinding aluminium stearate and an aluminium stearate binding agent in the presence of a carrier liquid to react the aluminium stearate and aluminium stearate binding agent.

12. A method according to claim 9 comprising adding wax particles to the electrostatic ink composition following the reaction of aluminium stearate and the aluminium stearate binding agent.

13. An electrostatic printing method comprising:
providing an electrostatic ink composition;
contacting the electrostatic ink composition with a latent electrostatic image on a surface to create a developed ink image;
transferring the developed ink image to a print substrate, the electrostatic ink composition comprising:
a carrier liquid;
aluminium stearate particles; and
an aluminium stearate binding agent dissolved in the carrier liquid, wherein the aluminium stearate binding agent comprises an acidic binding group which is bound to an aluminium stearate particle.

14. An electrostatic printing method according to claim 13 comprising forming an embellished image on the print substrate by contacting an embellishing material with the print substrate on which the developed ink image is disposed.

15. An electrostatic printing method according to claim 14, wherein the embellished image is the reverse image of the developed ink image on the print substrate.
